(19) United States
(12) Patent Application Publication
(10) Pub. No.: US 2026/0370943 A1
(43) Pub. Date: Nov. 19, 2026

(54) INFORMATION PROCESSING APPARATUS, IMAGE PICKUP APPARATUS, INFORMATION PROCESSING METHOD, AND STORAGE MEDIUM

(71) Applicant: CANON KABUSHIKI KAISHA, Tokyo (JP)

(72) Inventor: TOMOHIRO SUGAYA, Kanagawa (JP)

(21) Appl. No.: 19/465,322

(22) Filed: Jan. 30, 2026

(30) Foreign Application Priority Data
Feb. 26, 2025 (JP) 2025-028616

(51) Int. Cl. H04N 23/68

(52) U.S. Cl. CPC H04N 23/683; H04N 23/6811; H04N 23/6812

(57) ABSTRACT

An information processing apparatus includes one or more memories storing instructions, and one or more processors that, upon execution of the instructions, operate to detect first information on movement from video data generated by an image pickup apparatus, perform image stabilization processing using the first information, acquire second information on a speed or an acceleration of shake of the image pickup apparatus, restrict use of the first information in the image stabilization processing in a case where the second information is less than a first threshold value, and determine whether to restrict the use of the first information, by using the first information and the second information, in a case where the second information is greater than the first threshold value and less than a second threshold value.

### BACKGROUND

### Field of the Technology

The present disclosure relates to an information processing apparatus, an image pickup apparatus, an information processing method, and a storage medium.

### Description of the Related Art

Image stabilization processing for reducing image blur caused by camera shake such as hand shake involves detecting motion vectors between frames of video data generated by imaging, and then performing electronic image stabilization as image processing based on those motion vectors. However, in a case where a motion vector is detected that is influenced by the movement of a moving object when a moving object is captured (referred to as erroneous detection of a motion vector hereinafter), proper electronic image stabilization cannot be performed.

Japanese Patent Application Laid-Open No. 2018-159957 discloses an image pickup apparatus that predefines imaging scenes of athletes, pets, etc. that are prone to erroneous detection of motion vectors, and restricts the use of motion vectors in those imaging scenes.

### SUMMARY

An information processing apparatus according to one aspect of the present disclosure may include one or more memories storing instructions, and one or more processors that, upon execution of the instructions, operate to detect first information on movement from video data generated by an image pickup apparatus, perform image stabilization processing using the first information, acquire second information on a speed or an acceleration of shake of the image pickup apparatus, restrict use of the first information in the image stabilization processing in a case where the second information is less than a first threshold value, and determine whether to restrict the use of the first information, by using the first information and the second information, in a case where the second information is greater than the first threshold value and less than a second threshold value. An image pickup apparatus having the above information processing apparatus, an information processing method corresponding to the above information processing apparatus, and a storage medium storing a program that causes a computer to execute the above information processing method also constitute another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of a camera according to a first embodiment.

FIGS. 2A and 2B illustrate a relationship between an output of an angular velocity sensor and a determination threshold value in the first embodiment.

FIG. 3 is a flowchart illustrating processing according to the first embodiment.

FIG. 4 illustrates the configuration of a camera according to a second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the present disclosure.

### First Embodiment

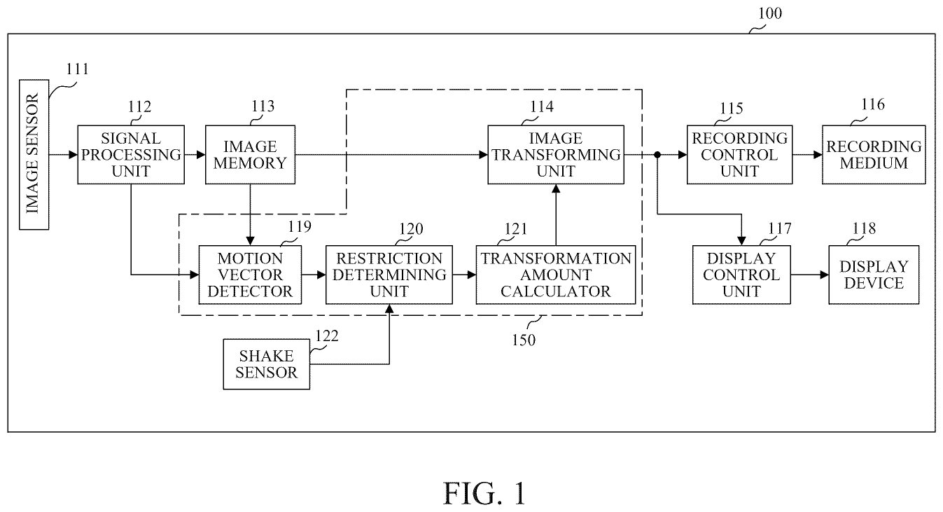

FIG. 1 illustrates the configuration of a camera 100 as an image pickup apparatus including an information processing apparatus 150 according to a first embodiment. The information processing apparatus 150 performs electronic image stabilization as image stabilization processing that reduces (corrects) image blur through image processing. Although the camera 100 is an interchangeable lens camera, the lens (optical system) is not illustrated. However, the camera 100 may also be a lens integrated type camera. This embodiment can provide optical image stabilization by moving a part of the lens (optical system) in a direction orthogonal to the optical axis, and also provide electronic image stabilization for correcting image shake that cannot be fully corrected by the optical image stabilization in the camera 100 (residual image shake).

The camera 100 includes an image sensor 111, a signal processing unit 112, an image memory 113, the information processing apparatus 150, a recording control unit 115, a display control unit 117, a display device 118, and an angular velocity sensor 122.

A light beam from an object passes through the lens and forms an optical image of the object on the image sensor 111. The image sensor 111 is a photoelectric conversion element such as a CCD sensor or CMOS sensor having a plurality of pixels, which converts the object image formed on the imaging surface into an electrical image signal. The signal processing unit 112 performs image processing such as noise reduction, gain control, A/D conversion, pixel interpolation, and color conversion on the image signal output from the image sensor 111, generating video data consisting of image data for each frame (referred to as frame image hereinafter). The frame images are stored in an image memory 113.

The information processing apparatus 150 includes an image transforming unit 114, a motion vector detector 119, a restriction determining unit 120, and a transformation amount calculator 121. The information processing apparatus 150 includes one or more unillustrated memories (such as a RAM and a ROM) storing instructions, and one or more processors (such as a CPU) that, upon execution of the instructions, operate to serve as the image transforming unit 114, the motion vector detector 119, the restriction determining unit 120, and the transformation amount calculator 121.

In this embodiment, the information processing apparatus 150 is built into the camera 100, but the information processing apparatus 150 may also be configured as a personal computer or the like separate from the camera 100. This is similarly applicable to a second embodiment described below.

The image transforming unit 114 sequentially reads frame images from the image memory 113, moves a cutout range in each frame image according to the transformation amount calculated by the transformation amount calculator 121 (described later), and sequentially outputs the image data of the cutout range as frame images. The video data including a plurality of frame images output from the image transforming unit 114 is supplied to the recording control unit 115 and the display control unit 117.

The motion vector detector 119, which serves as a motion detector, detects a motion vector between the frame image of the current frame (hereinafter referred to as the current frame image) from the video data and the frame image one frame before the current frame (referred to as the previous frame image hereinafter) stored in the image memory 113. Methods for detecting motion vectors include the block matching method described below.

In the block matching method, each frame image is divided into multiple blocks (areas), and similar parts between the previous frame image and the current frame image are detected on a block-by-block basis. Then, the block with the highest correlation value with the current frame image within an arbitrary range of the previous frame image is extracted as the similar block. The motion vector detector 119 then detects a motion vector as information (first information) on the movement that indicates the displacement amount and displacement direction between similar blocks in the previous frame image and the current frame image.

The motion vector detector 119 then determines a single representative motion vector that represents the entire frame image from the motion vectors for each block. For example, a histogram indicating the frequency (degree) of the magnitude (class) of the motion vector for each block is generated, and the motion vector with the highest frequency is determined as the representative motion vector. In the following description, motion vector refers to the representative motion vector.

The restriction determining unit 120, which serves as a restriction unit, determines whether to restrict (prohibit) or allow the use of the motion vector detected by the motion vector detector 119 in electronic image stabilization, and if allowed, outputs the motion vector to the transformation amount calculator 121. Details of the processing performed by the restriction determining unit 120 will be described later.

Based on the motion vector input from the restriction determining unit 120, the transformation amount calculator 121 calculates a transformation amount that includes a moving amount and a moving direction of the cutout range for each frame image so as to reduce positional shift between frame images caused by camera shake. The calculated transformation amount is output to the image transforming unit 114. As described above, the image transforming unit 114 moves the cutout range according to the transformation amount input for each frame image, and sequentially outputs the image data of the cutout range as frame images. Hence, video data in which image blur due to camera shake has been corrected is generated using a plurality of frame images output from the image transforming unit 114. Electronic image stabilization is thus performed. The transformation amount calculator 121 and the image transforming unit 114 form an image stabilizing unit.

The recording control unit 115 receives user instructions to start and end video recording via an unillustrated operation unit. In a case where video recording is instructed, the recording control unit 115 converts the video data supplied from the image transforming unit 114 into a format suitable for recording on a recording medium 116 such as a semiconductor memory, and records the converted data on the recording medium 116. The display control unit 117 displays the supplied video data on a display device 118 such as an LCD.

The angular velocity sensor 122 includes a gyro sensor or the like, and serves as a shake sensor that detects the angular velocity (second information) of camera shake, such as hand shake, applied to the camera 100, and outputs a signal corresponding to the angular velocity. A sensor that detects acceleration or angular acceleration may be used instead of the angular velocity sensor 122. In a case where the angular velocity sensor 122 outputs an analog signal corresponding to the angular velocity, the analog signal is A/D-converted to a digital signal, which is input to the restriction determining unit 120. In a case where the angular velocity sensor 122 outputs a digital signal corresponding to the angular velocity, the digital signal is input to the restriction determining unit 120 via serial communication.

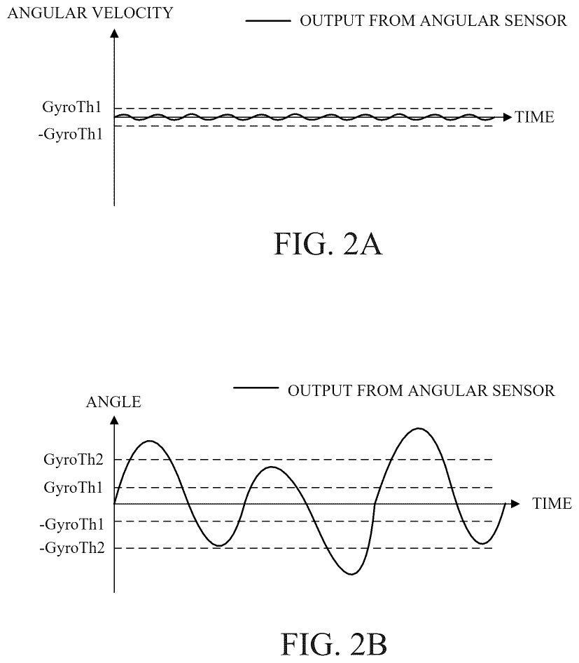

The restriction determining unit 120 performs the following processing. First, the restriction determining unit 120 determines the installation state of the camera 100 from the output (angular velocity) of the angular velocity sensor 122. FIG. 2A illustrates the change over time in the output of the angular velocity sensor 122 when the camera 100 is fixedly installed on a support member such as a tripod (referred to as a fixed installation state hereinafter).

In FIG. 2A, ±GyroTh1 are first threshold values used to determine that almost no camera shake is occurring in the fixed installation state. The restriction determining unit 120 can determine (consider) that the camera 100 is in the fixed installation state in a case where the absolute value of the output of the angular velocity sensor 122 (simply referred to as the output of the angular velocity sensor 122 hereinafter) is less than the absolute value of ±GyroTh1 (hereinafter simply referred to as GyroTh1).

To avoid an erroneous determination that the camera 100 is in the fixed installation state when the output of the angular velocity sensor 122 momentarily exceeds GyroTh1, the determination is made based on the output of the angular velocity sensor 122 over a predetermined period of time. For example, the camera 100 is determined to be in the fixed installation state in a case where the output of the angular velocity sensor 122 for one second is less than GyroTh1. This can be achieved by acquiring the output of the angular velocity sensor 122 at a frequency higher than the processing cycle of the restriction determining unit 120 and storing the output data within the predetermined period of time. The same applies when comparing the output of the angular velocity sensor 122 or a motion vector with other threshold values.

In a case where the restriction determining unit 120 determines that the camera 100 is in the fixed installation state, it prohibits the use of motion vectors in electronic image stabilization. In this case, electronic image stabilization is not performed. In a state where camera shake is small, such as in the fixed installation state, erroneous detection of motion vectors due to the influence of moving objects is more likely to occur than in a handheld state where the user holds the camera 100 in their hand. Unnatural movement is more likely to be noticeable in images after electronic image stabilization using this erroneously detected motion vector. For this reason, the use of motion vectors in electronic image stabilization is prohibited in the fixed installation state.

FIG. 2B illustrates the change over time in the output of the angular velocity sensor 122 when the camera 100 is handheld and experiencing greater camera shake than when the user is standing still (referred to as a fixed-position handheld state hereinafter). ±GyroTh2 is a second threshold value for determining that the camera 100 is in the fixed-position handheld state. The absolute value of ±GyroTh2 (simply referred to as GyroTh2 hereinafter) is smaller than GyroTh1. In a case where the output of angular velocity sensor 122 is equal to or greater than GyroTh1 and less than GyroTh2, the restriction determining unit 120 determines (considers) that camera 100 is in the fixed-position handheld state.

As illustrated in FIG. 2B, in a case where the output of angular velocity sensor 122 is equal to or greater than GyroTh2, the restriction determining unit 120 determines (considers) that camera 100 is not in the fixed-position handheld state, but is in the camera-moving state where a panning operation or the user is capturing images while walking. Thus, in a case where the output of angular velocity sensor 122 is equal to or greater than GyroTh2, the movement of the image due to camera shake is large, and the impact of erroneous detection of motion vectors for moving objects is small. Thus, the restriction determining unit 120 allows the use of motion vectors in electronic image stabilization.

In a case where the output of angular velocity sensor 122 is equal to or greater than GyroTh1 and less than GyroTh2, the restriction determining unit 120 determines whether or not a motion vector can be used in electronic image stabilization using MvTh, which is a third threshold value for motion vectors that is different from GyroTh1 and GyroTh2. MvTh changes according to the output of angular velocity sensor 122. More specifically, it is a threshold value that increases as the output of angular velocity sensor 122 increases. As will be described later, the restriction determining unit 120 does not allow the motion vector to be used in electronic image stabilization in a case where the magnitude of the motion vector is equal to or greater than MvTh. On the other hand, in a case where the motion vector is smaller than MvTh, it allows the motion vector to be used in electronic image stabilization.

In order to determine MvTh, first a reference motion vector is determined from an actual measurement value. For example, the magnitude of the motion vector and the magnitude of the angular velocity sensor 122 are measured in a semi-fixed installation state using a simple support member such as a monopod, which reduces camera shake compared to a fixed handheld state in a case where a lens capable of optical image stabilization is attached to the camera 100, or in the fixed installation state outdoors in strong winds. Then, once information on the magnitude of the motion vector relative to the magnitude of the angular velocity sensor 122 is obtained by such measurements, a value with a margin added to the magnitude of that motion vector (reference value) is determined as MvTh.

MvTh for the output of the angular velocity sensor 122 may not be converted into table data. Instead, MvTh can be calculated by calculating a coefficient k from the measurement results of the angular velocity sensor 122 and the motion vector, and then performing an operation such as MvTh=k×Gyro. Gyro indicates the output of the angular velocity sensor 122.

As discussed above, in a case where the output of the angular velocity sensor 122 is between GyroTh1 and GyroTh2, the ability to use the motion vector in electronic image stabilization in that state must be determined based on the magnitude of the motion vector. As discussed above, image movement resulting from electronic image stabilization using a motion vector that is erroneously detected due to the influence of a moving object in a state where camera shake is small is more noticeable than when camera shake is large. However, in a case where optical image stabilization is performed using a lens, the greater the camera shake compared to when the camera is in the fixed installation state, the more likely it is that uncorrected image blur will occur due to optical image stabilization. Therefore, supplementary electronic image stabilization may be performed using motion vectors to reduce this uncorrected image blur.

Thus, in a case where the magnitude of the motion vector is less than MvTh corresponding to the output of the angular velocity sensor 122, that is, in a case where the motion vector can be considered to indicate image blur remaining after correction by optical image stabilization, the motion vector is allowed to be used in electronic image stabilization. On the other hand, in a case where the magnitude of the motion vector is equal to or greater than MvTh corresponding to the output of the angular velocity sensor 122, the motion vector is considered to have been erroneously detected due to the influence of a moving object, and the motion vector is prohibited from being used in electronic image stabilization.

Thus, properly setting MvTh, which is a threshold value for the motion vector, according to the output of the angular velocity sensor 122 (the larger the output of the angular velocity sensor 122, the larger the setting) can accurately select erroneous detections of motion vectors.

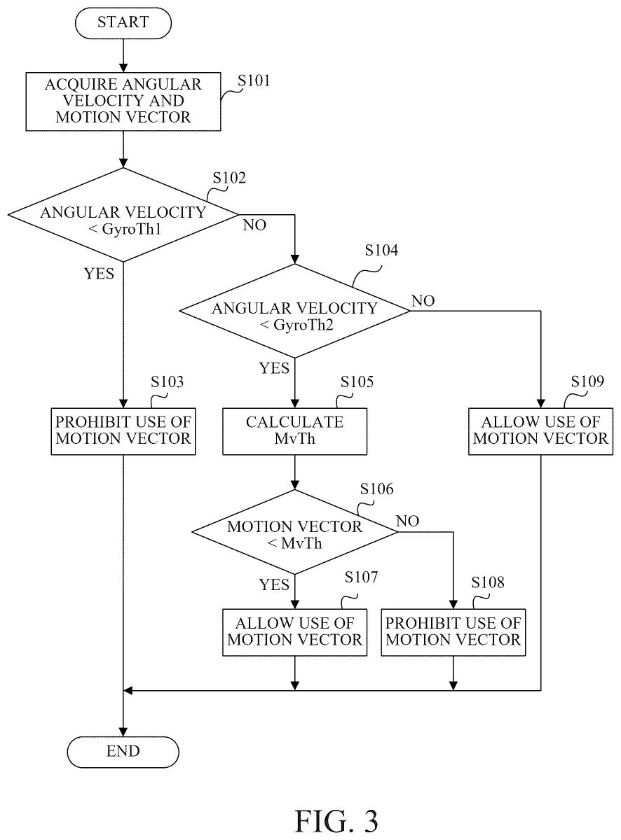

A flowchart in FIG. 3 illustrates the information processing method of the restriction determining unit 120 described above. The restriction determining unit 120 starts this processing in synchronization with the detection period of the motion vector, i.e., the frame rate of imaging by the camera 100, etc. The restriction determining unit 120, together with the signal processing unit 112, motion vector detector 119, transformation amount calculator 121, and image transforming unit 114, executes this processing according to a program as a computer including a CPU and MPU.

In step (process) S101, the restriction determining unit 120 acquires the angular velocity and motion vector from the angular velocity sensor 122 and motion vector detector 119.

Next, in step S102, the restriction determining unit 120 determines whether the angular velocity is less than GyroTH1. In a case where the angular velocity is less than GyroTh1, i.e., in a case where the camera 100 can be considered to be in the fixed installation state, the restriction determining unit 120 performs the processing of step S103, and in a case where the angular velocity is GyroTh1 or greater, the restriction determining unit 120 performs the processing of step S104.

In step S103, the restriction determining unit 120 prohibits the use of the motion vector in electronic image stabilization. In other words, electronic image stabilization is not performed.

On the other hand, in step S104, the restriction determining unit 120 determines whether the output of the angular velocity sensor 122 is less than GyroTH2. In a case where the output of the angular velocity sensor 122 is less than GyroTH2, i.e., in a case where the camera 100 can be considered to be in the fixed handheld position, the restriction determining unit 120 performs the processing of step S105, and in a case where the output of the angular velocity sensor 122 is GyroTH2 or greater, the restriction determining unit 120 performs the processing of step S109.

In step S105, the restriction determining unit 120 calculates a threshold value MvTh for the motion vector.

Next, in step S106, the restriction determining unit 120 compares MvTh calculated in step S105 with the magnitude of the motion vector acquired in step S101. In a case where the magnitude of the motion vector is less than MvTh, the restriction determining unit 120 performs the processing of step S107, and in a case where the magnitude of the motion vector is equal to or greater than MvTh, the restriction determining unit 120 performs the processing of step S108. In a case where the magnitude of the motion vector is equal to or greater than MvTh, this is, for example, in a case where the object has moved significantly (jumped, etc.) in a short period of time.

In step S107, the restriction determining unit 120 allows the use of the motion vector in electronic image stabilization for the reasons described above. On the other hand, in step S108, the restriction determining unit 120 prohibits the use of the motion vector in electronic image stabilization. This flow then ends. Thus, in steps S106 to S108 (the restriction processing), the restriction determining unit 120 determines whether or not to restrict the use of the motion vector in electronic image stabilization based on the comparison result between the motion vector and MvTh corresponding to the angular velocity.

In step S109, the restriction determining unit 120 considers that the camera 100 is in a camera movement state and prohibits the use of the motion vector in electronic image stabilization. This flow then ends.

Thus, the use of a motion vector in electronic image stabilization is prohibited in a case where the use of the motion vector is restricted, but the use of a motion vector may not be prohibited. For example, in a case where the output of angular velocity sensor 122 is equal to or greater than GyroTh1 but less than GyroTh2, and the magnitude of the detected motion vector is equal to or greater than MvTh (step S108), electronic image stabilization may be performed using a motion vector reduced by multiplying the detected motion vector by a coefficient smaller than 1. That is, compared to when the use of a motion vector in electronic image stabilization is allowed, the motion vector may be restricted from being used as is.

This embodiment determines the support state of camera 100 (fixed installation state, in a fixed handheld position, camera moving state, etc.) based on the output of angular velocity sensor 122, and whether or not the motion vector can be used in electronic image stabilization is properly determined based on the support state. Thereby, erroneous detection of motion vectors can be avoided and electronic image stabilization can properly work.

### Second Embodiment

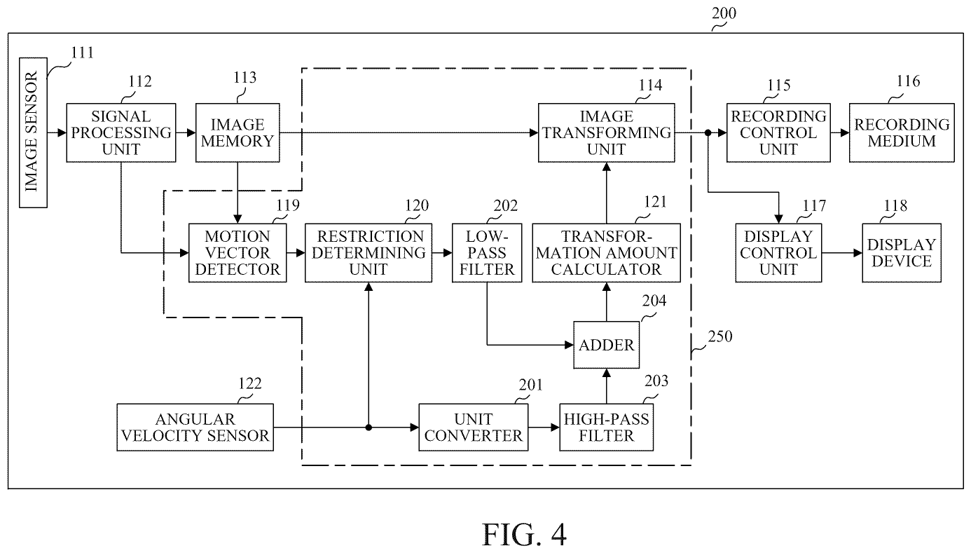

FIG. 4 illustrates the configuration of a camera 200 according to a second embodiment. In the first embodiment, the lens performs optical image stabilization and the camera 100 performs electronic image stabilization. However, in this embodiment, the lens does not perform optical image stabilization. The camera 200 may be different from the camera 100 according to the first embodiment having the configuration illustrated in FIG. 4, or the configuration of the camera 200 may be switchable between the configuration of the camera 100 according to the first embodiment and the configuration illustrated in FIG. 4 depending on whether the attached lens performs optical image stabilization. In the camera 200, those elements, which are corresponding elements in the camera 100 according to the first embodiment, will be designated by the same reference numerals, and a description thereof will be omitted.

In a case where the lens performs optical image stabilization and the camera performs electronic image stabilization based on camera shake detected by an angular velocity sensor, excessive image stabilization will be performed by the optical image stabilization and the electronic image stabilization. On the other hand, in a case where the lens does not perform optical image stabilization, the camera 200 can be expected to achieve good image stabilization by performing electronic image stabilization based on camera shake detected by the angular velocity sensor 122. However, in general, the output on the low-frequency side of an angular velocity sensor is prone to fluctuations due to temperature changes. Thus, in the camera 200 according to this embodiment, the angular velocity sensor 122 detects the angular velocity due to high-frequency camera shake, and low-frequency camera shake using a motion vector. As in the first embodiment, a shake sensor that detects acceleration or angular acceleration may be used instead of the angular velocity sensor 122.

The camera 200 includes the image sensor 111, the signal processing unit 112, the image memory 113, an information processing apparatus 250, the recording control unit 115, the display control unit 117, the display device 118, and the angular velocity sensor 122. The information processing apparatus 250 includes the image transforming unit 114, the motion vector detector 119, the restriction determining unit 120, the transformation amount calculator 121, a unit converter 201, a low-pass filter 202, a high-pass filter 203, and an adder 204. The information processing apparatus 250 includes one or more unillustrated memories (such as a RAM and a ROM) storing instructions, and one or more processors (such as a CPU) that, upon execution of the instructions, operate to serve as the image transforming unit 114, the motion vector detector 119, the restriction determining unit 120, the transformation amount calculator 121, the unit converter 201, the low-pass filter 202, the high-pass filter 203, and the adder 204.

The unit converter 201 converts the output of the angular velocity sensor 122 from angular velocity units into pixel units for detecting motion vectors by the motion vector detector 119. In addition to this unit conversion, the unit converter 201 also performs time adjustment to match the detection period of the motion vector. That is, the unit converter 201 outputs a pixel-converted value of the angular velocity detected at the frame rate period.

The unit adjustment of the angular velocity and motion vector is not limited to this example. For example, integration processing may be performed on the angular velocity and motion vector to obtain the value of the motion vector integrated at the detection timing of the motion vector and the value of the angular velocity integrated at the same timing, i.e., the pixel-converted value of the angle information.

The low-pass filter 202 extracts low-frequency shake components from the motion vector input from the motion vector detector 119 via the restriction determining unit 120. The high-pass filter 203 extracts high-frequency shake components from the angular velocity converted into pixels by the unit converter 201. The adder 204 outputs a signal obtained by adding the output of the low-pass filter 202 and the output of the high-pass filter 203 to the transformation amount calculator 121. The transformation amount calculator 121 calculates the transformation amount to be output to the image transforming unit 114 based on the signal from the adder 204. This configuration can provide a transformation amount that reduces fluctuations in the low-frequency output of the angular velocity sensor 122 due to temperature changes.

Inputting to the low-pass filter 202 a motion vector selected by the method described in the first embodiment so as to avoid erroneous detection of a motion vector due to a moving object can avoid erroneous detection of a motion vector and secure good functioning of electronic image stabilization. At this time, MvTh described in the first embodiment is a threshold value assuming that optical image stabilization is performed by the lens, but this embodiment determines MvTh by measuring the angular velocity and motion vector when the lens does not perform optical image stabilization.

However, a displacement amount d of an object image on the image sensor 111 due to camera shake can be calculated using the following equation:

d=f×tanθ

where θ is an angle over the frame rate period calculated from the output of the angular velocity sensor 122, and f is a focal length of the lens.

In this equation, the pixel-converted value of d corresponds to the motion vector. Therefore, MvTh may be determined based on this theoretical value rather than using the measurement results described above.

Even if the lens does not provide optical image stabilization, the camera 200 according to this embodiment can adopt the selection of whether or not to use a motion vector in electronic image stabilization, as described in the first embodiment.

In the first and second embodiments, the restriction determining unit 120 compares a motion vector with MvTh, which varies according to the angular velocity, to determine whether the use of the motion vector in electronic image stabilization can be allowed or prohibited.

On the other hand, MvTh may be set to a fixed value, and a determination motion vector may be used as determination information obtained by applying (multiplying) a gain that is variable according to the output of the angular velocity sensor to the motion vector, and this determination motion vector may be used to determine whether or not the motion vector can be used in electronic image stabilization. In other words, whether or not a motion vector can be used may be determined by comparing the fixed MvTh with the determination motion vector according to the angular velocity. In this case, too, in a case where the determination motion vector is larger than MvTh, the use of the motion vector in electronic image stabilization is restricted. The greater the output of the angular velocity sensor 122 is, the smaller the gain is.

In the first and second embodiments, electronic image stabilization using image processing is performed as image stabilization processing using a motion vector, but sensor image-stabilization may also be performed, in which control is exercised to move the image sensor 111 in a direction orthogonal to the optical axis, as image stabilization processing using a motion vector.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like. One or more of the functional blocks illustrated in FIGS. 1 and 4 may be implemented by hardware such as an ASIC or a programmable logic array (PLA), or by a programmable processor such as a CPU or MPU executing software. They may also be implemented by a combination of software and hardware. Therefore, even when different functional blocks are described as the main operation entities in the following description, they may be implemented by the same hardware.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can perform image stabilization by properly using a motion vector.

This application claims the benefit of Japanese Patent Application No. 2025-028616, filed on Feb. 26, 2025, and which is hereby incorporated by reference herein in its entirety.

What is claimed is:

1. An information processing apparatus comprising:
one or more memories storing instructions; and
one or more processors that, upon execution of the instructions, operate to:
detect first information on movement from video data generated by an image pickup apparatus,
perform image stabilization processing using the first information,
acquire second information on a speed or an acceleration of shake of the image pickup apparatus,
restrict use of the first information in the image stabilization processing in a case where the second information is less than a first threshold value, and
determine whether to restrict the use of the first information, by using the first information and the second information, in a case where the second information is greater than the first threshold value and less than a second threshold value.

2. The information processing apparatus according to claim 1, wherein the one or more processors operate to restrict the use of the first information in a case where the first information is greater than a third threshold value that is variable according to the second information.

3. The information processing apparatus according to claim 2, wherein the one or more processors operate to increase the third threshold value as the second information increases.

4. The information processing apparatus according to claim 1, wherein the one or more processors operate to restrict the use of the first information in a case where information obtained by applying a gain that is variable according to the second information to the first information is greater than a third threshold value.

5. The information processing apparatus according to claim 4, wherein the one or more processors operate to reduce the third threshold value as the second information increases.

6. The information processing apparatus according to claim 1, wherein the one or more processors operate not to perform the image stabilization processing by restricting the use of the first information.

7. The information processing apparatus according to claim 1, wherein the one or more processors operate to perform the image stabilization processing using information on movement that is smaller than the first information in a case where the use of the first information is restricted.

8. The information processing apparatus according to claim 1, wherein the one or more processors operate to restrict the use of the first information in a case where the second information is greater than the second threshold value.

9. The information processing apparatus according to claim 1, wherein the image stabilization processing is processing for moving a cutout range for each frame image included in the video data.

10. The information processing apparatus according to claim 1, wherein the image stabilization processing is processing for moving an image sensor in the image pickup apparatus.

11. The information processing apparatus according to claim 1, wherein the one or more processors operate to restrict use of the first information in the image stabilization processing.

12. An image pickup apparatus comprising:
an image sensor; and
an information processing apparatus;
wherein the information processing apparatus includes:
one or more memories storing instructions, and
one or more processors that, upon execution of the instructions, operate to:
detect first information on movement from video data generated by the image pickup apparatus,
perform image stabilization processing using the first information,
acquire second information on a speed or an acceleration of shake of the image pickup apparatus,
restrict use of the first information in the image stabilization processing in a case where the second information is less than a first threshold value, and
determine whether to restrict the use of the first information, by using the first information and the second information, in a case where the second information is greater than the first threshold value and less than a second threshold value.

13. An information processing method comprising:
detecting first information on movement from video data generated by an image pickup apparatus,
performing image stabilization processing using the first information,
acquiring second information on a speed or an acceleration of shake of the image pickup apparatus,
restricting use of the first information in the image stabilization processing in a case where the second information is less than a first threshold value, and
determining whether to restrict the use of the first information, by using the first information and the second information, in a case where the second information is greater than the first threshold value and less than a second threshold value.

14. A non-transitory computer-readable storage medium storing a program that causes a computer to execute the information processing method according to claim 13.
